(19) United States
(12) Patent Application Publication
(10) Pub. No.: US 2022/0383387 A1
(43) Pub. Date: Dec. 1, 2022

(54) INFORMATION PROCESSING APPARATUS AND INFORMATION PROCESSING METHOD

(71) Applicant: TOYOTA JIDOSHA KABUSHIKI KAISHA, Toyota-shi (JP)

(72) Inventors: Yuta Tone, Nagoya-shi (JP); Yukinori II, Toyota-shi (JP); Tadayuki Tanaka, Nagoya-shi (JP); Naoki Ishizuka, Nagoya-shi (JP); Yuichiro Yano, Nagakute-shi (JP); Nariaki Amano, Nagoya-shi (JP); Yusuke Maeda, Miyoshi-shi (JP); Kei Yazaki, Okazaki-shi (JP); Yu Hamada, Nagoya-shi (JP)

(73) Assignee: TOYOTA JIDOSHA KABUSHIKI KAISHA, Toyota-shi (JP)

(21) Appl. No.: 17/826,487

(22) Filed: May 27, 2022

(30) Foreign Application Priority Data
May 27, 2021 (JP) 2021-089568

(51) Int. Cl. G06Q 30/06

(52) U.S. Cl. CPC G06Q 30/0631

(57) ABSTRACT

An information processing apparatus obtains first information about first prescribed equipment. The first prescribed equipment is equipment that is not currently installed on a vehicle owned by a user, but has been considered by the user to be installed on the vehicle in the past. Then, the information processing apparatus determines the first prescribed equipment as equipment that is proposed to the user to be newly installed on the vehicle.

### CROSS REFERENCE TO THE RELATED APPLICATION

This application claims the benefit of Japanese Patent Application No. 2021-089568, filed on May 27, 2021, which is hereby incorporated by reference herein in its entirety.

### BACKGROUND

### Technical Field

The present disclosure relates to an information processing apparatus and an information processing method.

### Description of the Related Art

Patent Literature 1 discloses a technique related to a sales support device for automobiles. The sales support device disclosed in Patent Literature 1 sets a customized vehicle provided with the equipment selected in response to an equipment selection request.

### CITATION LIST

### Patent Literature

Patent Literature 1: Japanese Patent Application Laid-Open Publication No. 2004-252858

### SUMMARY

An object of the present disclosure is to provide a technique that makes it possible to propose to a user to install new equipment on a vehicle owned by the user.

An information processing apparatus according to a first aspect of the present disclosure may include a controller configured to perform:

obtaining first information about first prescribed equipment that is not currently installed on a vehicle owned by a user but has been considered by the user to be installed on the vehicle in the past; and

determining the first prescribed equipment as equipment that is proposed to the user to be newly installed on the vehicle.

An information processing apparatus according to a second aspect of the present disclosure may include a controller configured to perform:

obtaining second information about second prescribed equipment that is not currently installed on a vehicle owned by a user, but, when installed on the vehicle, makes a residual value of the vehicle higher than a current value thereof; and

determining the second prescribed equipment as equipment that is proposed to the user to be newly installed on the vehicle.

An information processing apparatus according to a third aspect of the present disclosure may include a controller configured to perform:

obtaining user information including first information about first prescribed equipment that has been considered by a user to be installed on a vehicle upon purchase of the vehicle but has not actually been selected as equipment to be installed on the vehicle by the user; and

storing the first information in a predetermined database.

An information processing method according to a fourth aspect of the present disclosure, which is executed by a computer, may include:

obtaining first information about first prescribed equipment that is not currently installed on a vehicle owned by a user but has been considered by the user to be installed on the vehicle in the past; and

determining the first prescribed equipment as equipment that is proposed to the user to be newly installed on the vehicle.

According to the present disclosure, it is possible to propose to a user that new equipment be installed on a vehicle owned by the user.

### BRIEF DESCRIPTION OF THE DRAWINGS

FIG. 1 is a view illustrating a schematic configuration of an information management system;

FIG. 2 is a block diagram schematically illustrating an example of a functional configuration of each of a store terminal and a management server;

FIG. 3 is a view illustrating an example of an operation screen of the store terminal;

FIG. 4 is a view illustrating an example of a table configuration of user information stored in a user information database according to a first embodiment;

FIG. 5 is a flowchart illustrating a flow of proposal processing; and

FIG. 6 is a view illustrating an example of a table configuration of user information stored in a user information database according to a second embodiment.

### DESCRIPTION OF THE EMBODIMENTS

A variety of equipment are installed on a vehicle. Then, when purchasing the vehicle or the like, a user can select equipment to be installed on the vehicle from among a plurality of options. In addition, even after purchasing the vehicle, the user may also want to replace equipment or add new equipment in the vehicle owned by the user.

Information processing apparatuses according to a first aspect and a second aspect of the present disclosure determine equipment that is proposed to a user to be newly installed on a vehicle owned by the user (hereinafter, may also referred to as the “user vehicle”). Specifically, in the information processing apparatus according to the first aspect of the present disclosure, a controller may obtain first information about first prescribed equipment corresponding to the user vehicle. Here, the first prescribed equipment is equipment that is not currently installed on the user vehicle, but has been considered by the user to be installed on the vehicle in the past. In other words, the first prescribed equipment is the equipment that has a past record of being of interest to the user. Therefore, even if the user has not selected the first prescribed equipment as the equipment to be actually installed on the user vehicle in the past, the user may later again want to install the first prescribed equipment on the user vehicle.

Accordingly, the controller, which has obtained the first information, may determine the first prescribed equipment as the equipment that is proposed to the user to be installed on the user vehicle (hereinafter, may also be referred to as the “proposal equipment”). According to this, it is possible to propose to the user the equipment that the user may want to install on the user vehicle.

In the information processing apparatus according to the second aspect of the present disclosure, a controller may obtain second information about second prescribed equipment corresponding to the user vehicle. Here, the second prescribed equipment is equipment that is not currently installed on the user vehicle, but, if installed on the user vehicle, will make the residual value of the user vehicle higher than the current value thereof. If the installation of the second prescribed equipment on the user vehicle will make the residual value of the user vehicle higher than the current value thereof, the user may want to install the second prescribed equipment on the user vehicle.

Therefore, the controller, which has obtained the second information, may determine the second prescribed equipment as the proposal equipment. This also makes it possible to propose to the user the equipment that the user may want to install on the user vehicle.

Hereinafter, specific embodiments of the present disclosure will be described based on the accompanying drawings. The dimensions, materials, shapes, relative arrangements, and the like of the components described in the embodiments are not intended to limit the technical scope of the present disclosure only to them unless otherwise specified.

### First Embodiment

### System Configuration

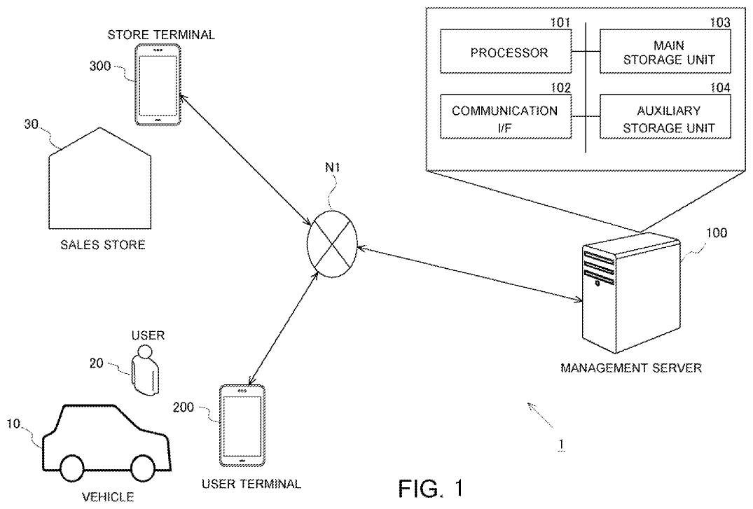

FIG. 1 is a view illustrating a schematic configuration of an information management system 1 according to a first embodiment. The information management system 1 is a system for proposing to a user to install new equipment on a vehicle owned by the user.

The information management system 1 includes a management server 100, a user terminal 200, and a store terminal 300. In the information management system 1, the management server 100, the user terminal 200, and the store terminal 300 are connected to one another via a network N1. Here, as the network N1, for example, a WAN (Wide Area Network), which is a worldwide public communication network such as the Internet, or a telephone communication network such as a cellular phone network may be adopted.

The user terminal 200 is a terminal possessed by the user 20 who owns the user vehicle 10. The store terminal 300 is a terminal used in a sales store 30 where the user 20 has purchased the user vehicle 10. The store terminal 300 is operated by a sales person in the sales store 30. The user terminal 200 and the store terminal 300 are each configured to include a computer having a processor, a main storage unit, an auxiliary storage unit, a communication interface, and an input and output interface. Examples of the user terminal 200 and the store terminal 300 may include smartphones, tablet computers, or personal computers.

The sales store 30 is a store (dealer or the like) that sells vehicles. In the sales store 30, when a customer (user) purchases a vehicle, vehicle information about the vehicle purchased by the customer is input to the store terminal 300. At the store terminal 300, user information about the user who purchased the vehicle is generated based on the input vehicle information. Then, the user information is transmitted from the store terminal 300 to the management sever 100 via the network N1. Note that details of the user information will be described later.

The management server 100 is configured to include a general computer. The computer constituting the management server 100 includes a processor 101, a communication interface (communication I/F) 102, a main storage unit 103, and an auxiliary storage unit 104.

Here, the processor 101 is, for example, a CPU (Central Processing Unit) or a DSP (Digital Signal Processor). The communication I/F 102 is an interface for performing wireless communication via the network N1 according to a predetermined wireless communication standard. The communication I/F 102 is, for example, a LAN (Local Area Network) interface board or a wireless communication circuit for wireless communication. The main storage unit 103 is, for example, a RAM (Random Access Memory). The auxiliary storage unit 104 is, for example, a ROM (Read Only Memory), an HDD (Hard Disk Drive), or a flash memory. In addition, the auxiliary storage unit 104 may also include a removable medium (portable storage medium). Here, the removable medium is, for example, a USB memory, an SD card, or a disk recording medium such as a CD-ROM, a DVD disk, or a Blu-ray disk.

The auxiliary storage unit 104 stores an operating system (OS), various programs, various information tables, and the like. The processor 101 loads a program stored in the auxiliary storage unit 104 into the main storage unit 103 and executes the program, thereby realizing processing for generating a database and processing for providing information, as will be described later. However, some or all of the functions of the management server 100 may be realized by a hardware circuit such as an ASIC or an FPGA. Here, note that the management server 100 does not necessarily need to be realized by a single physical configuration, but may be composed of a plurality of computers that work together.

The management sever 100 receives the user information transmitted from the store terminal 300. In addition, the management server 100 generates a database of user information by accumulating the received user information. The database in the management server 100 also stores user information about the user 20 who is the owner of the user vehicle 10. Then, the management server 100 determines proposal equipment based on the vehicle information of the user vehicle 10 included in the user information about the user 20. Here, the proposal equipment is equipment that is proposed to the user 20 to be newly installed on the user vehicle 10. Further, the management server 100 transmits the proposal information, which is information about the proposal equipment, to the user terminal 200 via the network N1. As a result, it is proposed to the user 20 that the proposal equipment be newly installed on the user vehicle 10.

### Functional Configuration

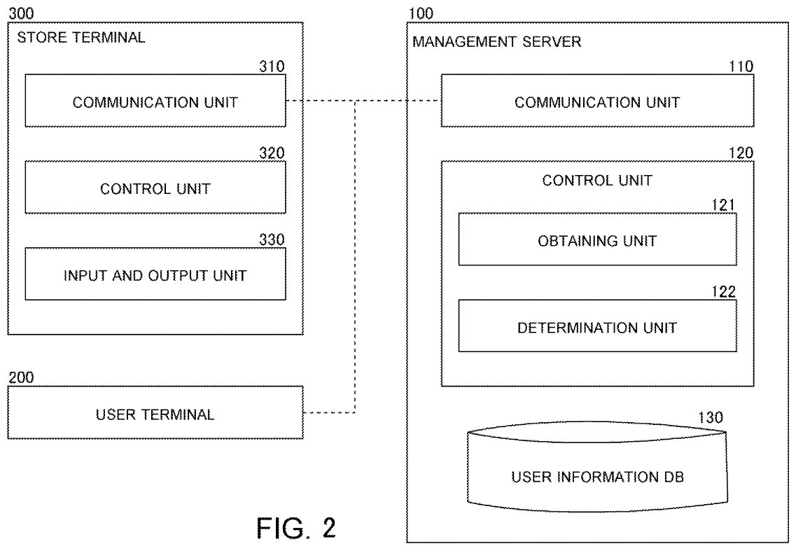

Next, a functional configuration of each of the store terminal 300 and the management server 100, which together constitute the information management system 1, will be described based on FIG. 2. FIG. 2 is a block diagram schematically illustrating an example of the functional configuration of each of the store terminal 300 and the management server 100. Note that in the present embodiment, the management server 100 corresponds to an information processing apparatus according to the present disclosure.

The store terminal 300 includes, as its functional units, a communication unit 310, a control unit 320, and an input and output unit 330. The control unit 320 has a function of performing arithmetic processing for controlling the store terminal 300. The control unit 120 can be implemented by a processor.

The communication unit 310 has a function of connecting the store terminal 300 to the network N1. The communication unit 310 can be implemented by a communication interface. Then, the control unit 320 performs the processing of transmitting the user information to the management server 100 by using the communication unit 310.

The input and output unit 330 has a function of receiving an input of information and a function of outputting information. The input and output unit 330 can be implemented by an input and output interface such as a touch panel display or the like. Then, the control unit 320 performs the processing of receiving vehicle information that is input by using the input and output unit 330. Further, in the store terminal 300, the control unit 320 executes the processing of generating the user information based on the received vehicle information.

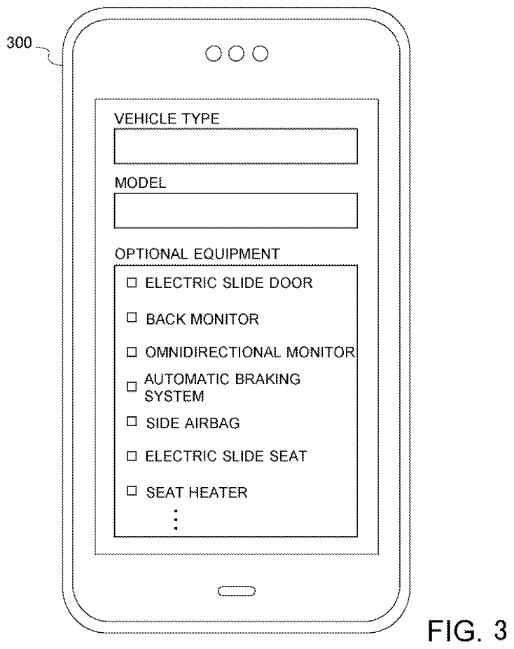

Here, at the sales store 30, vehicle information input to the store terminal 300 when the user purchases a vehicle will be described based on FIG. 3. FIG. 3 is a view illustrating an example of an operation screen displayed on a touch panel display that constitutes the input and output unit 330 in the store terminal 300. On the operation screen illustrated in FIG. 3, the type and model of the vehicle to be purchased by the user are entered. In addition, on the operation screen illustrated in FIG. 3, a list of optional equipment according to the type and model of the vehicle is displayed. Here, the optional equipment is equipment that allows the user to select whether or not to install it on the vehicle when purchasing the vehicle. The optional equipment has been set in advance by the vehicle manufacturer according to the type and model of the vehicle. As the optional equipment, there can be specifically exemplified an “electric slide door”, a “back monitor”, an “omnidirectional monitor”, an “automatic braking system”, a “side airbag”, an “electric slide seat”, a “seat heater”, or the like, as illustrated in FIG. 3. However, the optional equipment is not limited to these pieces of equipment.

Then, on the operation screen illustrated in FIG. 3, the equipment selected by the user as the equipment to be actually installed on the vehicle (hereinafter, may also be referred to as the “installed equipment”) is entered by using the list of optional equipment. Further, on the operation screen illustrated in FIG. 3, this list of optional equipment is used to enter the equipment that has been considered by the user to be installed on the vehicle but has not actually been selected as the equipment to be installed on the vehicle by the user (hereinafter, may also be referred to as the “considered equipment”). The considered equipment is, for example, the equipment that was once considered by the user to be installed on the vehicle when an estimate of the selling price of the vehicle was prepared in order for the user to consider the purchase of the vehicle.

Then, at the store terminal 300, the control unit 320 generates user information to be transmitted to the management sever 100 based on the vehicle information entered through the input and output unit 330 as described above. Therefore, the user information includes, as the vehicle information, information about the type and model of the vehicle purchased by the user, information about the installed equipment (installed equipment information), and information about the considered equipment (considered equipment information).

The management server 100 includes, as its functional units, a communication unit 110, a control unit 120, and a user information database (user information DB) 130. The communication unit 110 has a function of connecting the management server 100 to the network N1. The communication unit 110 can be implemented by the communication I/F 102.

The control unit 120 has a function of performing arithmetic processing for controlling the management server 100. The control unit 120 may be implemented by the processor 101. Then, the control unit 120 performs the processing of receiving the user information transmitted from the store terminal 300 by using the communication unit 110. Further, the control unit 120 performs the processing of storing the user information received from the store terminal 300 in the user information DB 130. Note that the user information DB 130 is built in the auxiliary storage unit 104 by the processor 101 executing a program of a database management system. Every time user information is received from the store terminal 300, the control unit 120 adds the received user information to the user information DB 130. Therefore, the user information DB 130 stores user information about each of a plurality of users.

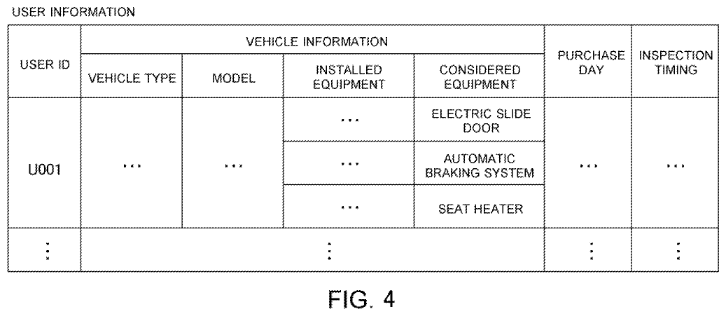

FIG. 4 is a view illustrating an example of a table configuration of the user information stored in the user information DB 130 according to the present embodiment. As illustrated in FIG. 4, the user information includes a user ID field, a vehicle information field, a purchase date field, and an inspection timing field. In the user ID field, a user ID, which is identification information for identifying a user who purchased a vehicle, is entered. In the vehicle information field, vehicle information is entered for the vehicle purchased by the user. As described above, the vehicle information includes information about the type and model of the vehicle purchased by the user, as well as installed equipment information and considered equipment information. In the purchase date field, the date on which the user purchased the vehicle is entered. In the inspection timing field, an inspection timing of the vehicle, e.g., a timing at which the user should have the vehicle inspected, is entered. Here, the inspection timing may be, for example, a legally defined timing or period. Also, the inspection timing may be a timing that is independently determined by the vehicle manufacturer or the sales store 30.

Here, note that in the present embodiment, the user information DB 130 corresponds to a “predetermined database” according to the present disclosure. In addition, in the present embodiment, the considered equipment corresponds to “first prescribed equipment” according to the present disclosure. Moreover, the considered equipment may be equipment that can replace the equipment currently installed on the user vehicle.

In addition, the control unit 120 executes proposal processing to propose to the user 20 to install new equipment on the user vehicle 10 at a predetermined proposal timing after the user 20 has purchased the user vehicle 10. The control unit 120 has an obtaining unit 121 and a determination unit 122 as its functional units for executing the proposal processing.

### Proposal Processing

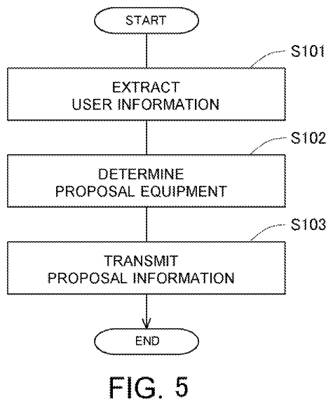

Hereinafter, a flow of the proposal processing to be executed by the control unit 120 in the management server 100 will be described based on FIG. 5. FIG. 5 is a flowchart illustrating the flow of the proposal processing. As described above, the user 20 has purchased the user vehicle 10 at the sales store 30. Therefore, user information about the user 20 has been stored in the user information DB 130 of the management sever 100.

Moreover, the flow illustrated in FIG. 5 is executed at a predetermined proposal timing that is determined based on the inspection timing of the user vehicle 10 in the user information about the user 20. Here, the predetermined proposal timing is a timing before the inspection timing of the user vehicle 10 by a predetermined period of time. That is, the control unit 120 executes the proposal processing for the user of the vehicle for which the predetermined proposal timing has arrived, based on the inspection timing in the user information of each user stored in the user information DB 130.

Here, note that the predetermined proposal timing does not necessarily have to be a timing determined based on the inspection timing of the vehicle. For example, the control unit 120 may execute the proposal processing for the user 20 every time a certain period of time elapses after the day on which the user 20 purchased the user vehicle 10 (purchase date).

In the flow of the proposal processing illustrated in FIG. 5, first, in S101, user information about the user 20 stored in the user information DB 130 is extracted. This processing of S101 is executed by the obtaining unit 121. As a result, the obtaining unit 121 obtains the considered equipment information for the user 20.

Then, in S102, proposal equipment for the user 20 is determined based on the considered equipment information obtained by the obtaining unit 121. This processing of S102 is executed by the determination unit 122. In this way, the determination unit 122 determines, as proposal equipment for the user 20, the equipment that has been considered by the user 20 to be installed on the user vehicle 10 upon purchase of the user vehicle 10 but has not actually been selected as equipment to be installed on the user vehicle 10 by the user 20.

Subsequently, in S103, proposal information, which is information about the proposal equipment determined by the determination unit 122, is transmitted to the user terminal 200. As a result, at the predetermined proposal timing, it is proposed to the user 20 that the proposal equipment be newly installed on the user vehicle 10. Note that in S103, the control unit 120 may transmit information about the inspection timing of the user vehicle 10 to the user terminal 200 together with the proposal information. With this, it is possible to notify the user 20 of the inspection timing of the user vehicle 10.

The considered equipment indicated by the considered equipment information in the user information about the user 20 is equipment that is not currently installed on the user vehicle 10 but has been considered by the user 20 to be installed on the user vehicle 10 in the past. In other words, the considered equipment is the equipment that has a past record of being of interest to the user 20. Therefore, even if the user 20 did not select the considered equipment as installed equipment at the time of purchasing the user vehicle 10, the user 20 may again want to install the considered equipment on the user vehicle 10 after the purchase of the user vehicle 10.

Therefore, according to the information management system 1 of the present embodiment, it is possible to propose to the user 20 the equipment that the user 20 may want to install on the user vehicle 10. In addition, according to the proposal processing described above, the considered equipment is proposed to the user 20 as the proposal equipment at the predetermined proposal timing that is determined based on the inspection timing of the user vehicle 10. According to this, it is possible to encourage the user 20 to install the considered equipment on the user vehicle 10 in accordance with the timing of performing the inspection of the user vehicle 10.

Here, note that in the present embodiment, the equipment, which the user considered to install on the vehicle at the time of purchasing the vehicle, is used as the considered equipment. However, the considered equipment may be equipment that has been considered by the user to be installed on the vehicle after the purchase of the vehicle but has not actually been installed on the vehicle.

### First Modification

The considered equipment indicated by the considered equipment information in the user information about the user 20 may include equipment that, if newly installed on the user vehicle 10, will make the residual value of the user vehicle 10 higher than the current value thereof. Therefore, when determining the proposal equipment for the user 20 in the proposal processing, the control unit 120 of the management sever 100 may select the proposal equipment that, when newly installed on the user vehicle 10, will make the residual value of the user vehicle 10 higher than the current value thereof, and may determine it as the proposal equipment. According to this, it becomes possible to propose to the user 20 the equipment that the user 20 is more likely to want to install on the user vehicle 10.

Here, note that whether or not each piece of considered equipment is equipment that, when newly installed on the user vehicle 10, makes the residual value of the user vehicle 10 higher than the current value thereof can be determined based on the market value of each piece of the considered equipment. Therefore, the management sever 100 may obtain information about the market value of each piece of the considered equipment. Then, based on the obtained information about the market value of each piece of the considered equipment, the control unit 120 may select the considered equipment that, when newly installed on the user vehicle 10, makes the residual value of the user vehicle 10 higher than the current value thereof.

### Second Modification

In addition, in the management server 100, when storing the user information of the user 20 received from the store terminal 300 into the user information DB 130, the control unit 120 may select considered equipment included in the considered equipment information to be stored in the user information DB 130. In this case, the control unit 120 may select, from among pieces of equipment included in the considered equipment information, pieces of considered equipment that are of a higher grade than the installed equipment included in the installed equipment information of the user information. Then, the control unit 120 controls such that only the selected pieces of considered equipment are included in the considered equipment information in the user information to be stored in the user information DB 130.

According to this, in the proposal processing, those pieces of considered equipment having a higher grade than the installed equipment will be determined as the proposal equipment for the user 20. In other words, when the proposal equipment for the user 20 is determined, the considered equipment that, when newly installed on the user vehicle 10, will make the residual value of the user vehicle 10 higher than the current value thereof will be determined as the proposal equipment.

### Second Embodiment

A schematic configuration of an information management system according to a second embodiment is the same as that of the first embodiment. Hereinafter, differences from the first embodiment in the information management system according to the present embodiment will be mainly described.

After a user 20 purchases a user vehicle 10, optional equipment that can be installed on the user vehicle 10 may be additionally released by the manufacturer of the user vehicle 10. At this time, the user 20 may want to install the additionally released optional equipment (hereinafter, may also be referred to as the “additional option”) on the user vehicle 10.

Therefore, in the present embodiment, when optional equipment is additionally released, the management sever 100 obtains information about the additional option (additional option information). Here, when the optional equipment is additionally released, the additional option information may be input to the store terminal 300 by a sales person of the sales store 30. Then, the additional option information may be transmitted from the store terminal 300 to the management sever 100 via the network N1. Thus, the management server 100 can obtain the additional option information. Note that the additional option information may be directly input to the management server 100.

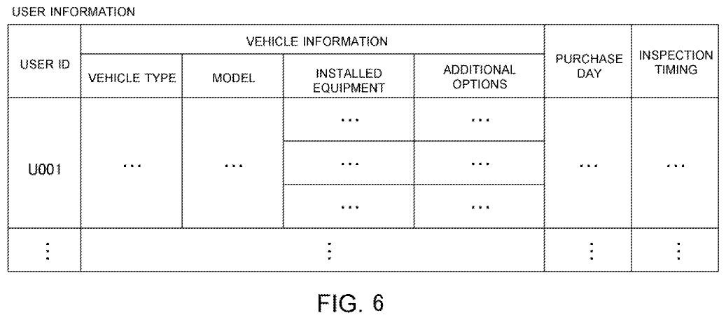

Then, in the present embodiment, in the management server 100, the control unit 120 adds the additional option information to the user information stored in the user information DB 130 as vehicle information. FIG. 6 is a view illustrating an example of a table configuration of the user information stored in the user information DB 130 according to the present embodiment. As illustrated in FIG. 6, in the vehicle information field of the user information according to the present embodiment, the additional option information is entered in place of the considered equipment information in the user information (see FIG. 4) according to the first embodiment.

Then, in this embodiment, too, the management server 100 executes the proposal processing based on the user information stored in the user information DB 130. In other words, in the management server 100, when executing the proposal processing for the user 20, the control unit 120 extracts the user information about the user 20 stored in the user information DB 130. Accordingly, the control unit 120 obtains the additional option information about the user 20.

Further, the control unit 120 selects, from among the additional options indicated by the additional option information about the user 20, equipment that, when newly installed on the user vehicle 10, will make the residual value of the user vehicle 10 higher than the current value thereof. At this time, the control unit 120 may select, from among the equipment included in the additional option information, an additional option having a higher grade than the installed equipment included in the installed equipment information in the user information. Then, the control unit 120 determines the additional option thus selected as proposal equipment. In addition, the control unit 120 transmits the proposal information, which is information about the determined proposal equipment, to the user terminal 200.

The additional option is equipment that is not currently installed on the user vehicle 10, similar to the considered equipment according to the first embodiment. However, unlike the considered equipment according to the first embodiment, the additional option is not the equipment that has been considered by the user 20 to be installed on the user vehicle 10 in the past. However, if the additional option is equipment that, when newly installed on the user vehicle 10, makes the residual value of the user vehicle 10 higher than the current value thereof, the user 20 may want to install the additional option on the user vehicle 10.

Therefore, according to the information management system 1 of the present embodiment, too, it is possible to propose to the user 20 the equipment that the user 20 may want to install on the user vehicle 10.

Here, note that in the present embodiment, the additional option that, when newly installed on the user vehicle 10, makes the residual value of the user vehicle higher than the current value thereof corresponds to “second prescribed equipment” according to the present disclosure. In addition, the additional option may be equipment that can replace the installed equipment currently installed on the user vehicle. Moreover, in the present embodiment, the management server 100 may obtain, in addition to the additional option, information about equipment that is not currently installed on the user vehicle, but, if installed on the user vehicle, will make the residual value of the user vehicle higher than the current value thereof. In this case, the management sever 100 may determine the equipment indicated by the obtained information as the proposal equipment.

### Modifications

In the second embodiment described above, in the vehicle information field of the user information stored in the user information DB 130, the additional option information is entered in place of the considered equipment information according to the first embodiment. However, in the vehicle information field of the user information stored in the user information DB 130, both the considered equipment information and the additional option information may be entered. Then, in the proposal processing, the control unit 120 may determine both the considered equipment and the additional option as the proposal equipment.

Here, note that in the first and second embodiments, after determining the proposal equipment for the user 20, the management sever 100 does not necessarily have to transmit the proposal information to the user terminal 200. For example, the management sever 100 may transmit the proposal information to the store terminal 300. In this case, the proposal equipment for the user 20 can be suggested to a sales person of the sales store 30. As a result, the sales person of the sales store 30 can propose the proposal equipment to the user 20.

In addition, in the information management system 1, the store terminal 300 may have the functions of the management server 100 described above. Also, in the information management system 1, the user terminal 200 may have the functions of the store terminal 300 described above.

### Other Embodiments

The embodiments described above are merely examples, and the present disclosure may be changed and implemented as appropriate within the scope of the disclosure. Furthermore, processes and means described in the present disclosure may be freely combined to the extent that no technical conflict exists.

Furthermore, a process that is described to be performed by one apparatus may be shared and performed by a plurality of apparatuses. Processes described to be performed by different apparatuses may be performed by one apparatus. Which function is to be implemented by which hardware configuration (server configuration) in a computer system may be flexibly changed.

The present disclosure may also be implemented by supplying computer programs for implementing the functions described in the embodiments described above to a computer, and by one or more processors of the computer reading out and executing the programs. Such computer programs may be provided to the computer by a non-transitory computer-readable storage medium that can be connected to a system bus of the computer, or may be provided to the computer through a network. The non-transitory computer-readable storage medium may be any type of disk including magnetic disks (floppy (registered trademark) disks, hard disk drives (HDDs), etc.) and optical disks (CD-ROMs, DVD discs, Blu-ray discs, etc.), and any type of medium suitable for storing electronic instructions, such as read-only memories (ROMs), random access memories (RAMs), EPROMs, EEPROMs, magnetic cards, flash memories, or optical cards.

What is claimed is:

1. An information processing apparatus including a controller configured to perform:
obtaining first information about first prescribed equipment that is not currently installed on a vehicle owned by a user but has been considered by the user to be installed on the vehicle in the past; and
determining the first prescribed equipment as equipment that is proposed to the user to be newly installed on the vehicle.

2. The information processing apparatus according to claim 1, wherein
the first prescribed equipment is equipment that has been considered by the user to be installed on the vehicle upon purchase of the vehicle, but has not actually been selected as equipment to be installed on the vehicle by the user.

3. The information processing apparatus according to claim 1, wherein
the controller determines, as the equipment to be proposed to the user to be newly installed on the vehicle, the first prescribed equipment that, when installed on the vehicle, makes a residual value of the vehicle higher than a current value thereof.

4. The information processing apparatus according to claim 1, wherein
the controller obtains the first information from a predetermined database in which the first information has been stored.

5. The information processing apparatus according to claim 1, wherein
the controller further performs proposing to the user that the first prescribed equipment be newly installed on the vehicle.

6. The information processing apparatus according to claim 5, wherein
the controller proposes to the user that the first prescribed equipment be newly installed on the vehicle, at a predetermined proposal timing that is determined based on an inspection timing of the vehicle.

7. The information processing apparatus according to claim 1, wherein the controller further performs:
obtaining second information about second prescribed equipment that has not been considered by the user to be installed on the vehicle in the past, but, when installed on the vehicle, makes a residual value of the vehicle higher than a current value thereof; and
determining the second prescribed equipment as equipment that is proposed to the user to be newly installed on the vehicle.

8. An information processing apparatus including a controller configured to perform:
obtaining second information about second prescribed equipment that is not currently installed on a vehicle owned by a user, but, when installed on the vehicle, makes a residual value of the vehicle higher than a current value thereof; and
determining the second prescribed equipment as equipment that is proposed to the user to be newly installed on the vehicle.

9. The information processing apparatus according to claim 8, wherein
the second prescribed equipment is equipment that was not included in the options selectable by the user when the user purchased the vehicle.

10. The information processing apparatus according to claim 8, wherein
the controller obtains the second information from a predetermined database in which the second information has been stored.

11. The information processing apparatus according to claim 8, wherein
the controller further performs proposing to the user that the second prescribed equipment be newly installed on the vehicle.

12. The information processing apparatus according to claim 11, wherein
the controller proposes to the user that the second prescribed equipment be installed on the vehicle, at a predetermined proposal timing that is determined based on an inspection timing of the vehicle.

13. An information processing apparatus including a controller configured to perform:
obtaining user information including first information about first prescribed equipment that has been considered by a user to be installed on a vehicle upon purchase of the vehicle but has not actually been selected as equipment to be installed on the vehicle by the user; and
storing the first information in a predetermined database.

14. The information processing apparatus according to claim 13, wherein
the controller stores in the predetermined database the first information about the first prescribed equipment that is of a higher grade than the equipment actually selected by the user as equipment to be installed on the vehicle when purchasing the vehicle.

15. An information processing method to be executed by a computer, comprising:
obtaining first information about first prescribed equipment that is not currently installed on a vehicle owned by a user but has been considered by the user to be installed on the vehicle in the past; and
determining the first prescribed equipment as equipment that is proposed, to the user, to be newly installed on the vehicle.

16. The information processing method according to claim 15, wherein
the first prescribed equipment is equipment that has been considered by the user to be installed on the vehicle upon purchase of the vehicle, but has not actually been selected as equipment to be installed on the vehicle by the user.

17. The information processing method according to claim 15, further comprising:
determining, as the equipment that is proposed to the user to be newly installed on the vehicle, the first prescribed equipment that, when installed on the vehicle, makes a residual value of the vehicle higher than a current value thereof.

18. The information processing method according to claim 15, further comprising:
obtaining the first information from a predetermined database in which the first information has been stored.

19. The information processing method according to claim 15, further comprising:
proposing to the user that the first prescribed equipment be newly installed on the vehicle.

20. The information processing method according to claim 15, further comprising:
obtaining second information about second prescribed equipment that has not been considered by the user to be installed on the vehicle in the past by the user, but, when installed on the vehicle, makes a residual value of the vehicle higher than a current value thereof; and
determining the second prescribed equipment as equipment that is proposed, to the user, to be newly installed on the vehicle.
